(19) United States
(12) Patent Application Publication
(10) Pub. No.: US 2015/0160689 A1
(43) Pub. Date: Jun. 11, 2015

(54) CONFIGURATION OF EXTERNAL CLOCK SIGNAL FOR A STORAGE MODULE

(71) Applicant: Memory Technologies LLC, Las Vegas, NV (US)

(72) Inventor: Kimmo Juhani Mylly, Ylojarvi (FI)

(21) Appl. No.: 14/566,496

(22) Filed: Dec. 10, 2014

Related U.S. Application Data
(60) Provisional application No. 61/914,308, filed on Dec. 10, 2013.

(51) Int. Cl. G06F 1/08

(52) U.S. Cl. CPC G06F 1/08

(57) ABSTRACT

A storage module includes a storage controller having a control circuit that manages the operation of the storage module in at least a first state and a second state. The storage module also includes memory blocks connected to the storage controller. The memory blocks form a mass storage. A clock generation circuit connected to the storage controller and a reference clock terminal is configured to receive an external clocking signal and to generate an internal clocking signal based on the external clocking signal. The storage controller is configured to receive data, based on the internal clock signal, from the external device on a data terminal while the storage module is in the second state. The storage module also includes a first register containing data that describes a property of the external clocking signal in the first state.

### RELATED APPLICATIONS

The present application claims priority to U.S. Provisional Application No. 61/914,308, filed Dec. 10, 2013, and entitled “CONFIGURATION OF EXTERNAL CLOCK SIGNAL FOR A STORAGE MODULE,” which is incorporated herein in its entirety. This application is related to U.S. application Ser. No. 12/455,763, filed Jun. 4, 2009, now patented as U.S. Pat. No. 8,874,824, U.S. application Ser. No. 13/451,951, filed Apr. 20, 2012, U.S. application Ser. No. 13/596,480, filed Aug. 28, 2012, and U.S. application Ser. No. 11/176,669, filed Jul. 8, 2005, now patented as U.S. Pat. No. 7,827,370, each of which are assigned to the assignee of the present application. Each of these related applications are incorporated herein by reference in their entireties.

### BACKGROUND

Managed storage modules, such as managed NAND storage modules, provide many benefits over using raw memories such as flash NAND memories. Managed storage modules, which typically include a storage controller combined with NAND memory in the case of managed NAND or other types of memory in other cases, provide several benefits to device manufacturers. The storage controller hides the details of the memory (e.g., NAND) and provides the intended interface and other features, such as ECC support without the device manufacturers having to implement those features on the host device side (e.g., on a phone, a tablet, or similar device). Additionally, managed storage modules allow new advanced features to be implemented in the storage controller without the host device being aware that the features exist. The advanced features can either be activated or not used depending by the storage controller depending on whether the host device supports the features. Thus, managed storage modules improve backwards compatibility.

Examples of managed storage modules, and in particular managed NAND storage modules, include embedded MultiMedia Cards (eMMC), Unified Flash Storage (UFS), Solid-State Drive (SSD) modules, or the like. These modules are used in wide variety of applications like mobile phones, Global Positioning System (GPS) devices, media players, PCs, and servers for storing the operating system code, applications, and user data, such as, the Operating System (OS) code, photos, and videos. Along with the data visible to the host device, operational code/firmware (FW) of the storage module itself is stored in the memory of the storage module. Additionally, other important data, which is used to operate the memory module, such as register data and address translation data, may be stored in the memory.

In storage modules that use a high-speed differential serial interface, a clock signal is typically embedded into the data signal to enable low pin count implementations that do not use a separate clock signal pin. However, to minimize the phase locked loop (PLL) locking time and bit error rate (BER), some type of reference clock may be beneficial, such as for gigabit per second level transmissions. However, when a reference clock runs continuously, extra power is consumed, thereby quickly draining a battery of a mobile device. Instead of continuously running the clock, the reference clock may be turned off when it is not being used.

However, in some circumstances, a range of different implementations may be supported. For example, a fixed specification regarding a reference clock for all devices in a particular operating state may limit the flexibility for device manufactures to implement different designs.

### SUMMARY

A storage device includes a storage controller, one or more blocks of memory coupled to the storage controller, a power supply terminal, a reference clock terminal, a data terminal coupled to the storage controller, a clock generation circuit coupled to the storage controller and the reference clock terminal, and a first set of registers. The storage controller includes a control circuit to operate the storage device in at least a first state or a second state. Each of the one or more blocks of memory have a plurality of memory circuits to store data. The one or more blocks of memory collectively form a storage. The power supply terminal supplies power to the storage device. The reference clock terminal is configured to provide to the storage module an external clock signal from a first external device. The data terminal is configured to couple to a second external device. The clock generation circuit is configured to receive the external clock signal and to generate an internal clock signal based at least in part upon the external clock signal. The storage controller is configured to receive data, based on the internal clock signal, from the second external device in response to the storage device being in the second state. The first set of registers include one or more registers to store data that relates to a property of the external clock signal in the first state of the storage device.

A memory device includes controlling means for controlling the memory device in at least a first state and a second state; storage means for storing data where the storage means includes a plurality of memory circuits; power means for supplying power to the memory device; reference clock means for providing an internal clock signal to the memory device; data terminal means for coupling the memory device to an external device; clock generation means coupled to the storage controller and to the reference clock terminal where the clock generation means is configured for receiving an external clock signal from an external source; and generating the internal clock signal based at least in part upon the external clock signal. The storage controller is configured to receive data, based on the internal clock signal, from the external device when the memory device is in the second state. The memory device includes first register means for storing data that relates to a property of the external clock signal when the memory device in the first state of the memory device.

A host device includes a system memory; a reference clock that is configurable by the host device; an interface for interfacing the host device with a storage device where the storage device includes a plurality of memory circuits to store data, and where the storage device operates in at least a first state and a second state; a host controller configured to (1) send, to the storage device, a request for reference clock specifications; (2) receive, from the storage device, the reference clock specifications; and (3) configure the reference clock according to the reference clock specifications. The reference clock is further configured to provide a reference clock signal to the storage device.

A method includes receiving, at a memory device, a request from a host device to provide reference clock specifications. The method also includes reading data from one or more registers of the memory device. The method further includes determining the reference clock specifications based at least partly on the data. The method includes sending the reference clock specifications from the memory device to the host device. The method also includes receiving, by the memory device, a reference clock signal that has parameters according to the reference clock specifications.

### BRIEF DESCRIPTION OF THE DRAWINGS

FIG. 1 depicts an example host device.

FIG. 2 depicts an embodiment of a storage module.

FIG. 3 depicts a graphic representation of the states of a first example state machine.

FIG. 6 depicts a graphic representation of the states of a second example state machine.

FIG. 4 depicts a process flow of a first embodiment of the present disclosure where the storage module communicates clock specification of the storage module to the host.

FIG. 5 depicts a process flow of a second embodiment of the present disclosure where the storage module communicates the clock specification of the storage module to the host.

The figures depict embodiments of the present disclosure for purposes of illustration only. One skilled in the art will readily recognize from the following discussion that alternative embodiments of the structures and methods illustrated herein can be employed without departing from the principles of the present disclosure described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

High-speed transfer of data may depend on exact timing between the source and destination devices. Up to certain transfer speeds, a clocking signal may be extracted from the rising and falling edges of a data signal without the need for a separate clocking signal to synchronize the source device and the destination device. However, as transfer speeds increase, a reference clock signal is useful to provide accurate synchronization between the source and the destination sufficient to support high-speed data transfers. For example, a host device may provide a reference clock to a storage module. The storage module may then use a clocking circuit (e.g., a phased locked loop (“PLL”) or similar mechanism) to generate an internal clocking signal to support the high-speed transfer of data between the host device and the storage module. The storage module includes a storage device (also known as a memory device).

While using a reference clock signal to generate an internal clocking signal may improve data transfer performance, supplying a reference clock and running a clocking circuit to generate an internal clocking signal consumes a significant amount of power. If high-speed data transfer is not in progress (e.g., the storage module is in an idle state), then the power consumed by the clocking circuit is wasted. Therefore, in certain states (e.g., when high-speed data transfers are not being performed) it may be useful to stop supplying the reference clock signal, to turn off the clocking circuit, or to do both. This may be done in order to conserve power. However, without coordination between a host device that supplies a reference clock signal and a storage module that uses the reference clock signal, the host device may not supply a reference clock that meets the clock specifications of the storage module (or not provide the reference clock at all) when the storage module is relying on the reference clock for receiving or sending data. Some of the embodiments of the present disclosure described herein enable a host device and storage module to configure whether the reference clock signal is used in a particular operating state and to configure parameters associated with the reference clock signal.

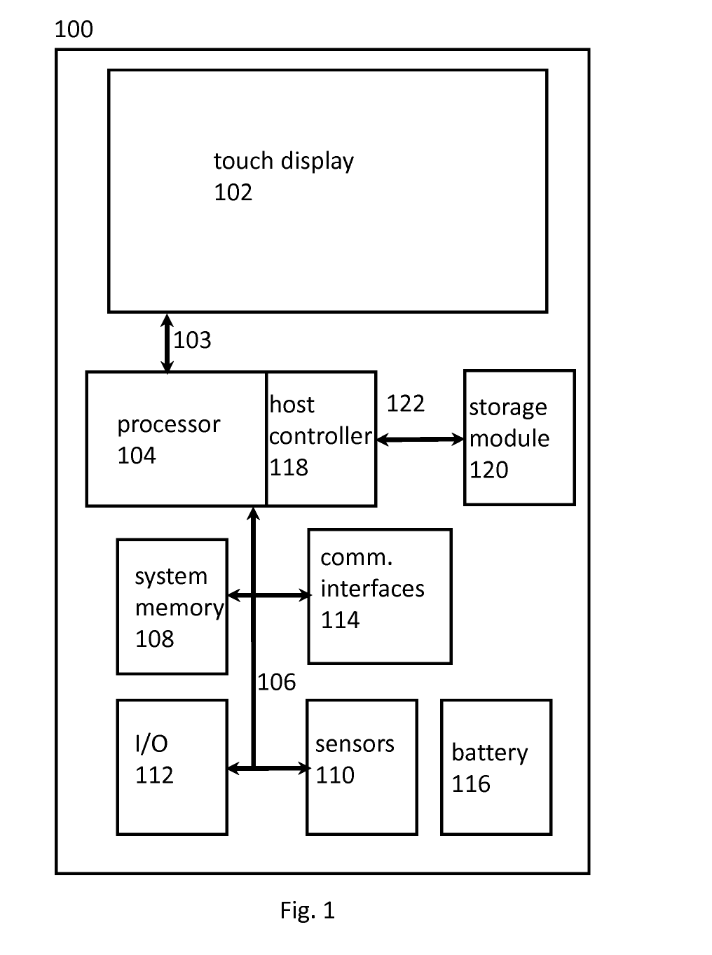

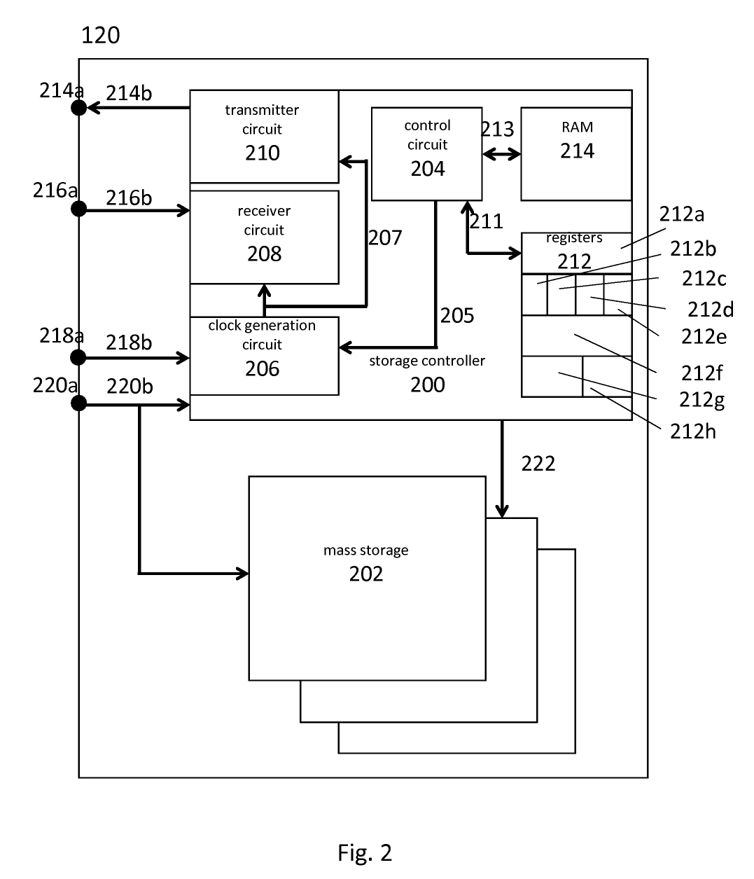

FIG. 1 depicts an example host 100, e.g., a host device such as a smartphone device or a tablet device, that may utilize embodiments of the present disclosure. Host 100 includes a touch display 102 that is sensitive to a user's touch based on capacitive or resistive detection. Bus 103 connects touch display 102 to processor 104, which may include a graphics subsystem that handles the display of graphics and text on touch display 102. Host 100 also includes a number of other components connected to processor 104 through shared bus 106, including system memory 108 (e.g., random access memory (RAM)), sensors 110 (e.g., accelerometers, gyroscope, GPS), input/output (I/O) 112 (e.g., a speaker, a microphone, or a keyboard), and communications interfaces 114 (e.g., universal serial bus (USB), WiFi (802.11), Bluetooth, or other wired or wireless interfaces). Processor 104 may also include host controller 118 (which may be alternatively connected to but is separate from processor 104) that interfaces with storage module 120 over bus 122. Alternatively, host controller 118 may interface with storage module 120 over shared bus 106. Both shared bus 106 and bus 122 may include several bus lines for data, commands, clocking signals, power, reset, etc. An example of the bus lines included in bus 122 is described below with respect to FIG. 2. Battery 116 provides power to the above described components through a power supply terminal or power supply bus and/or lines (not shown).

While the use of storage module 120 is shown in the context of a touch sensitive smartphone or tablet, the present disclosure is not limited to use in such devices. Embodiments of the present disclosure may be applied to any electronic device that uses storage, e.g., wearable computers such as smartwatches or glasses, televisions, cameras, netbooks, gaming consoles, personal computers, servers, set top boxes, and the like. Additionally, the architecture of host 100 is provided for illustrative purposes only and should not be considered limiting.

FIG. 2 depicts an exemplary architecture for storage module 120 that may implement embodiments of the present disclosure. Storage module 120 may be a memory device within a package (e.g., a ball grid array (BGA) package) that is designed to be mounted on a printed circuit board. For example, storage module 120 may be an embedded multimedia card (eMMC) or universal flash storage (UFS) module. Such memory types may use different ways of organizing the data, such as banks or blocks. Unless otherwise indicated herein, reference to a memory “block” also refers to a memory “bank.” The storage module 120 may be a memory device within a removable card that fits within a slot on the host 100 or a semi-removable device such as an SSD module or PC/server cards/modules (e.g., PCIe cards). Additionally, although storage module 120 is shown as being a single self-contained device, storage module 120 may be implemented using a collection of interconnected devices. Furthermore, one or more memory blocks may collectively form a storage.

As shown in FIG. 2, storage module 120 includes storage controller 200 for communicating data between mass storage 202 and host 100 (see FIG. 1). Storage controller 200 includes control circuit 204 for controlling the operation of storage controller 200. Control circuit 204 may be connected to RAM 214 over bus 213 for storing operating information and/or temporary storage as used by storage module 120. Storage controller 200 includes clock generation circuit 206 for generating an internal clocking signal on internal clock line 207, receiver circuit 208 for receiving data and commands from host controller 118 (see FIG. 1), transmitter circuit 210 for transmitting data and status information to host controller 118 (see FIG. 1), and registers 212 for storing information and settings relating to the operation of storage module 120, including information related to the generation of the internal clock. Control circuit 204 may use bus 211 to access or write information to registers 212. Storage module 120 communicates with host controller 118 through data out line 215b and data terminal 215a, which may provide data and status information, and data in line 216b and data terminal 216a, which may provide data, commands, and status information.

Storage module 120 also includes reference clock line 218b and reference clock terminal 218a that provide a reference clock signal to clock generating circuit 206, and power line 220b and power terminal 220a that provide power to storage controller 200 and mass storage 202. While the above lines and terminals are shown to be single lines and terminals in FIG. 2, each line and terminal may be made up of multiple lines and terminals. For example, power terminal 220a may include multiple terminals associated with multiple lines of power line 220b that each individually provide power to the different components (e.g., mass storage 202 and storage controller 200). As another example, data out line 215b and data out terminal 215a or data in line 216b and data in terminal 216a may be implemented using two lines (e.g., a differential pair or a 2-bit wide bus) connected to two terminals. Bus 222 provides allows for storage controller 200 to read data from and write data to mass storage 202.

Storage module 120 also includes mass storage 202, which includes one or more memory blocks on one or more chips having memory circuits (e.g., memory cells) for storing one or more bits of information. For example, mass storage 202 may be implemented with a non-volatile memory such as NAND flash memory having memory cells/circuits (e.g., NAND cells) that are each capable of storing one bit (single level cell) or multiple bits (multi-level cell) of data. Other forms of non-volatile memory can also be used without departing from the present disclosure. Mass storage 202 may be physically divided, logically divided, or both. For example, mass storage 202 may be implemented as a single chip. Alternatively, mass storage 202 may be implemented using several discrete chips that are connected together in a single package (as shown in FIG. 2) or, alternatively, separately packaged and externally connected together. Mass storage 202 may be divided up into multiple blocks, which are then further divided into multiple pages. Storage controller 200 is connected to mass storage 202 through bus 222, which allows for storage controller 200 to read data from, and write data to, mass storage 202.

RAM 214 is present in some embodiments of the present disclosure; storage controller 200 may use RAM 214 to store operating information (e.g., operating code, state information, or both) that may be readily/quickly accessed. For example, RAM 214 may store a translation table that describes how logical addresses are mapped to physical addresses of mass storage 202. When RAM 214 is not implemented within storage module 120, in some cases, storage controller 200 may instead request and use a portion of system memory 108 of host 100 (see FIG. 1), as described in U.S. patent application Ser. No. 12/455,763, filed Jun. 4, 2009, which is incorporated by reference in its entirety.

Clock generation circuit 206 may be implemented using a circuit that is capable of generating a clock signal. For example, clock generation circuit 206 may be implemented using clock recovery and/or generation circuits, such as phase locked loops (PLLs), oscillators, voltage controlled oscillators (VCOs), delay locked loops, frequency detectors, frequency multipliers/dividers, phase detectors, another type of suitable circuit or any combination thereof. Clock generation circuit 206 may rely on other components, such as resistors, capacitors, inductors, crystals, or MEMS devices. Clock generation circuit 206 may be programmable to output a clocking signal that varies according to the inputs that it receives. For example, clock generation circuit 206 may be configured to produce a clocking signal of a very high quality (e.g., low jitter) when a reference clock signal is present on reference clock line 218b. Clock generation circuit 206 may be configured to produce a clocking signal of a lower quality (e.g., higher jitter) when a reference clock signal is absent. In addition, in some embodiments, the frequency, duty cycle, jitter, output skew, or propagation delay of the outputted clocking signal may be set according to inputs (e.g., control bits) that are provided to clock generation circuit 206 through bus 205. In some architectures, clock generation circuit 206 may directly access registers 212 without going through control circuit 204 or clock generation circuit 206 may have an internal register for storing clock configuration information. While clock generation circuit 206 is shown to be part of storage controller 200, clock generation circuit 206 may also be implemented external to storage controller 200 in some implementations.

Receiver circuit 208 and transmitter circuit 210 receive the internal clock signal on internal clock line 207 to enable storage module 120 to transfer data to host 100 at higher rates than without a clock signal. In some embodiments, internal clock line 207 provides the internal clock signal to the receiver circuit 208, but not to the transmitter circuit 210. In other embodiments, internal clock line 207 provides the internal clock signal to the transmitter circuit 210, but not to the receiver circuit 208.

Registers 212 store one or more bits of information regarding the operation of storage module 120, including information regarding the operation of clock generation circuit 206 or other features of storage module 120. Registers 212 may be implemented as part of storage controller 200, as part of mass storage 202, as part of RAM 214, or as part of some other memory circuit in storage module 120. The memory used for registers 212 may be any type of memory. For example, registers 212 may be implemented in volatile memory (e.g., SRAM, DRAM, or the like), non-volatile memory (e.g., flash memory, magnetic memory, resistive memory), read-only memory (ROM), one time programmable memory, or any combination of different types of memory.

Registers 212 may include multiple individual registers, e.g., registers 212a-212h of similar or different sizes. For example, register 212a may be a 1-byte register while registers 212b-212e are 1-bit registers and register 212f is a 4-byte register. Registers 212 can be used to store several different types of information. In some cases, one or more of registers 212 store read-only information that describes how storage module 120 operates (e.g., supported features) or specifications for storage module 120 to operate at different levels of performance (e.g., different specifications for different transfer rates). In other cases, one or more of registers 212 may store writeable information that configures how storage module 120 operates or what storage module 120 requests from the host 100 in order to operate. One or more of registers 212 store information associated with how storage module 120 is currently operating or a current state of storage module 120. Together, registers 212 may store different types of information as described herein, along with other types of data. Registers 212 may also be used to implement descriptors, flags, and attributes as described in Joint Electron Device Engineering Council (JEDEC) Standard No. 220A for Universal Flash Storage (UFS 1.1), published June 2012, which is incorporated by reference herein in its entirety.

In some cases, registers 212 store information that describes a region of mass storage 202 that is write protected (e.g., either permanently or temporarily). For example, register 212f may define an address range, a block range, a partition, or the like that defines the region that is write protected. Another register, e.g. register 212g, may define whether the region is permanently, temporarily, or authenticated write protected. In the case of permanent or temporary, the region is protected as described in U.S. Pat. No. 7,827,370, filed Jul. 8, 2005, which is hereby incorporated by reference in its entirety. However, in the case of the region being authenticated write protected, the region may be written/programmed to if the data to be written is successful authenticated.

Control circuit 204 may include a state machine or several state machines. Alternatively, as another example, control circuit 204 may include a general purpose processor or microcontroller that is programmed to control storage module 120. For example, a processor programmed with firmware may implement one or more state machines that govern the operation of storage module 120. Firmware or other software for programming control circuit 204 may be stored in dedicated storage or in a reserved storage area on mass storage 202. As an alternative, control circuit 204 may be implemented as a combination of a general purpose processor programmed with firmware or the like and special purpose circuitry to perform specific functions.

Among the aspects of storage module 120 that control circuit 204 controls is the operation of clock generation circuit 206. In particular, using information stored in registers 212 and state information, which, in some examples, may also be stored in registers 212 or alternatively in RAM 214, control circuit 204 supplies control information (e.g., control bits) to clock generation circuit that can control the operation of the internal clock signal.

Other functions of control circuit 204 include receiving command signals from host 100 to perform certain functions. For example, control circuit 204 may receive command signals from host 100 to read information from or write information to registers 212. For instance, control circuit 204 may receive a command to read registers 212 in a location that stores a state of storage module 120 (e.g., a power state, a programming state, etc.).

It should be understood that the architecture of FIG. 2 is an example that is provided for ease of discussion only and should not be considered limiting. Circuits, buses, lines, modules and the like may have been simplified, left out, or otherwise combined with other components in FIG. 2 for ease of discussion. For example, although storage module 120 is shown to have buses such as internal clock line 207, bus 205, bus 213, bus 211, and bus 222, in some cases, these buses may be removed, combined, rerouted, and/or added to without departing from the spirit of the present disclosure described herein. As another example, the functionality of control circuit 204 may be greatly expanded over what is described herein or the functions described herein by control circuit 204 may be spread across different circuits.

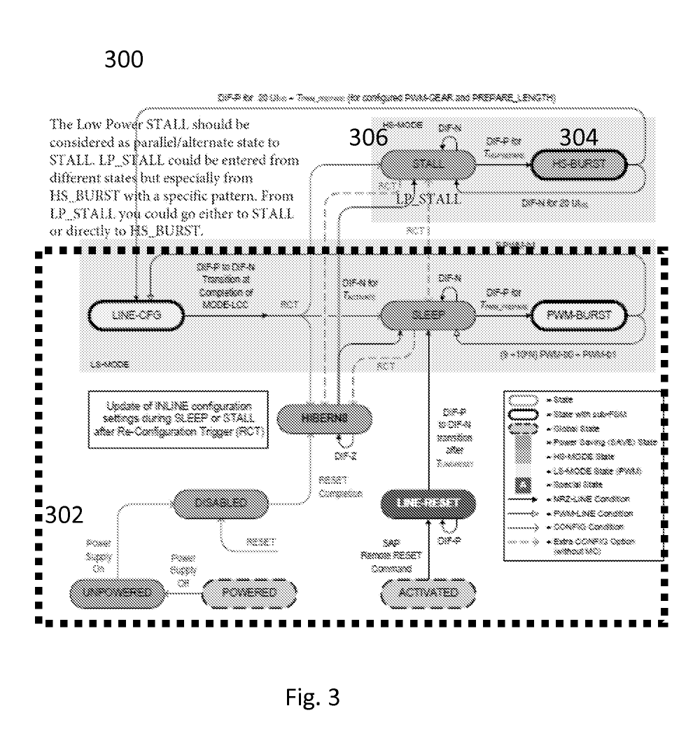

FIG. 3 depicts an example state diagram, state diagram 300, for an exemplary state machine. If a control circuit is used to implement this exemplary state machine, for states 302 (which represent various power-up, low power, and low speed transfer states), an external reference clock signal would not be used. In state 304 (a high-speed transfer state), the external reference clock signal is supplied to the storage module 120 (e.g., storage module 120 uses the external reference clock signal to properly operate). However, in state 306, where no high-speed transfer of data is occurring, whether the external reference clock signal is used may be configurable by the host, the storage module, or through a negotiation between the host and the storage module. The configuration of the specification of the external reference clock signal is described in more detail below.

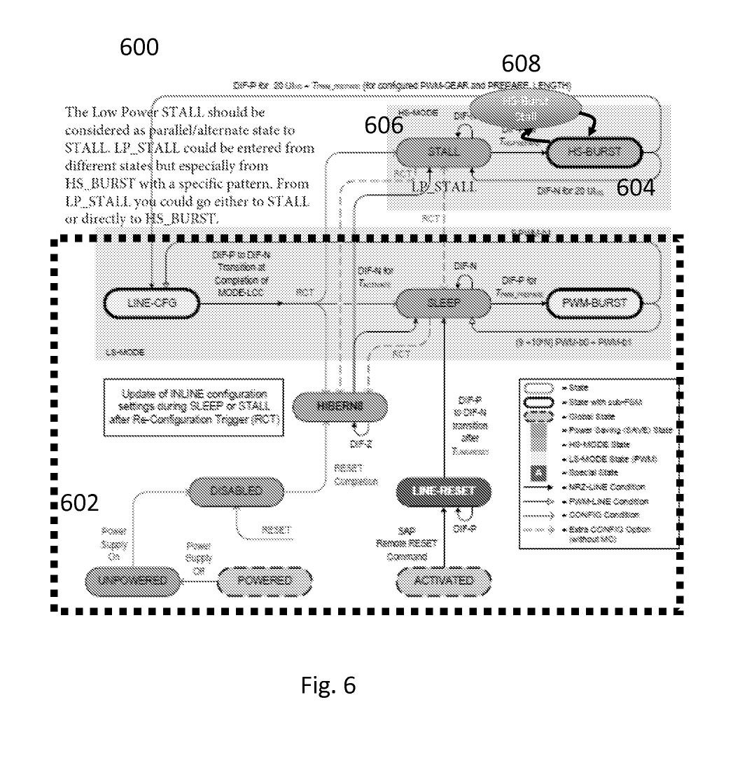

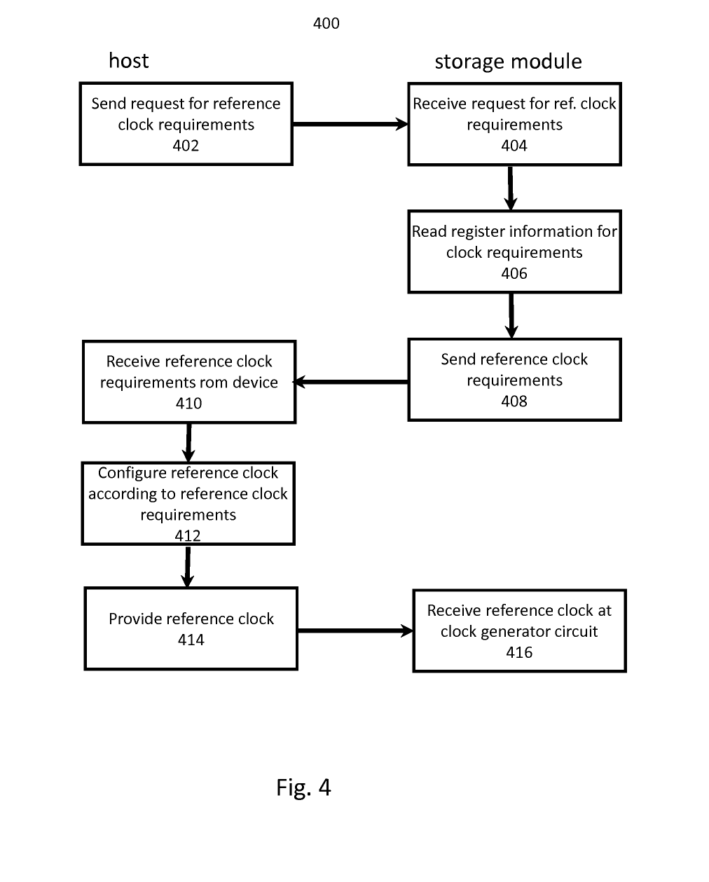

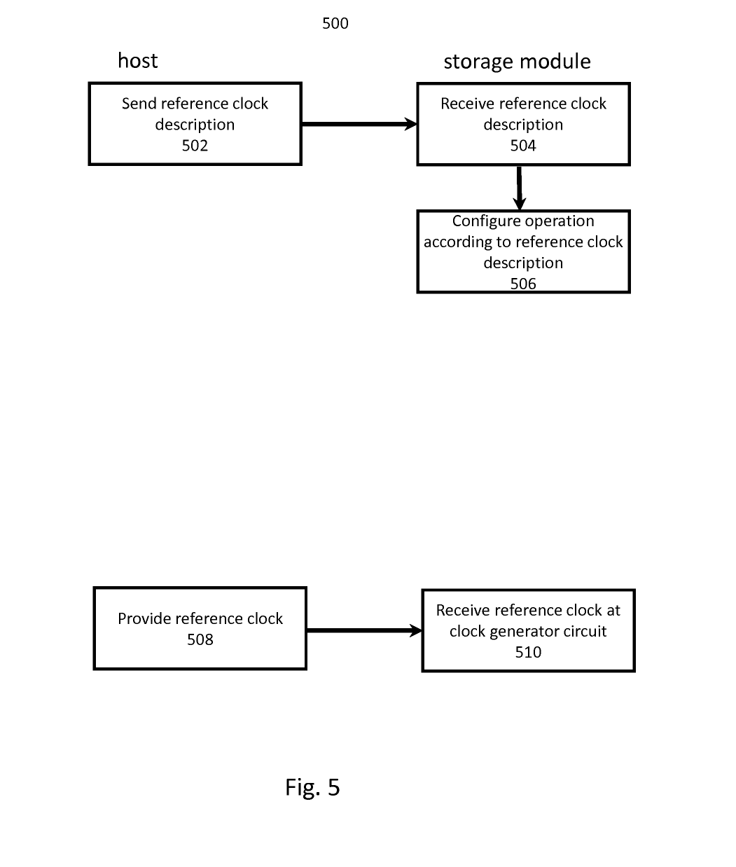

FIG. 6 depicts another example state diagram, state diagram 600, for another exemplary state machine. If a control circuit is used to implement this exemplary state machine, for states 602 (which represent various power-up, low power, and low speed transfer states), an external reference clock signal is not used by storage module 120. In state 604 (a high-speed transfer state), the external reference clock signal is specified as being supplied to the storage module 120 (e.g., storage module 120 uses the external reference clock signal to properly operate). In state 606, where no high-speed transfer of data is occurring, the external reference clock signal is not supplied from the host. However, the transition from state 606 to 604 may result in a significant delay period during which the reference clock supplied to reference clock terminal 218a stabilizes and clock generation circuit 206 initializes and starts to provide the internal clocking signal on internal clock line 207. Accordingly, state 608 is introduced that shortens the transition time to state 604 (i.e., the transition time from state 608 to 604 is shorter than the transition from state 606 to 604). In state 608, whether the external reference clock signal is specified may be configurable by the host, the storage module, or through a negotiation between the host and the storage module. The configuration of the specifications of the external reference clock signal is described in more detail below.

In a first embodiment of a storage module according to the present disclosure, host 100 is configured to determine whether storage module 120 specifies a reference clock signal that is to be supplied in a particular state of storage module 120. For example, register 212b may store data that indicates whether storage module 120 specifies an external reference clock signal in one or more states of operation (e.g., state 306 of FIG. 3 or state 608 of FIG. 6).

Alternatively, the information stored in register 212f may provide further specifications for the external reference clock signal in one or more states of operation. For example, register 212f may store a frequency, a frequency error, input voltages (high or low), a rise time, a fall time, a duty cycle, a phase noise, a noise floor density, an input impendence, and/or other parameters that are specified for the external reference clock signal to enable the storage module 120 to properly operate.

Registers 212 may store information about specifications for the external reference clock signal in each of multiple states. For example, in a first state, storage module 120 may specify a very high quality (e.g., low jitter) or frequency reference clock signal, while in a second state, storage module 120 may be able to operate with a low quality (e.g., higher jitter) or low frequency reference clock signal and in a third state, storage module 120 may not use a reference clock signal. One or more registers of registers 212 may be assigned to describe the reference clock signal specifications or operation in each of the three states.

With reference to FIG. 4, exemplary process 400 describes how the host controller and storage module may operate in this embodiment. In step 402, host 100 may send a request (e.g., through host controller 118) for storage module 120′s reference clock specifications. This request may take any form. For example, the request may be a read command for a specific register that is known to contain the relevant reference clock specifications. As another example, the request may be a specialized command that requests reference clock specifications.

In step 404, the storage module 120 receives the request for reference clock specifications. In step 406, the storage module 120 reads one or more of registers 212 that include the requested specifications. In step 408, the storage module 120 sends the requested reference clock specifications to host 100. Step 408 may be in response to 402, or alternatively, step 408 may be in response to a second (e.g., read) command different from the command sent in step 402.

In step 410, host 100 receives the reference clock specifications, which may apply globally to all states of operation of the storage module 120 or may, for example, be specific to a particular state of operation. In step 412, host 100 configures the reference clock according to the reference clock specifications received in step 410.

In step 414, host 100 provides the reference clock according to the reference clock specifications. For example, the host 100 may know the state information of storage module 120 and, based on the state information, provide the reference clock according to the reference clock specifications. For instance, host 100 may read state information from register 212a of storage module 120. Alternatively, the state may be communicated to host 100 on a periodic basis or continuously tracked by host 100. In one example, based on the reference clock specifications received from storage module 120, host 100 controller provides the reference clock signal when storage module 120 is in a first state (e.g., high speed data transfer) but stops providing the reference clock signal when storage module 120 is in a second state (e.g., idle or no data transfer). This result could be achieved by storage module 120 communicating with host 100 in steps 408 and 410 that the reference clock is used in the first state and/or that the reference clock is not used in the second state.

In step 416, the storage module receives the reference clock signal per the previously provided reference clock specifications.

In a second embodiment host 100 informs storage module 120 when the external reference clock signal will be provided by sending commands to storage module 120 that write configuration information to registers 212. Alternatively, host 100 informs storage module 120 of the properties of the external reference clock signal in one or more states.

For example, FIG. 5 depicts exemplary process 500 for this embodiment. In step 502, host 100 sends a description of the reference clock to storage module 120. In one case, the description of the reference clock is simply a message that indicates whether the reference clock will be provided in a particular state. In another case, the description of the reference clock includes an indication of whether the reference clock will be provided in each of a first state and a second state. In yet another case, the description of the reference clock includes an indication of whether the reference clock will be provided in a first state and further includes information that describes operating parameters of the reference clock (e.g., frequency, jitter, another related parameter, or any combination thereof).

In step 504, storage module 120 receives the reference clock description. For example, this step could take the form of a write command to a one or more specific registers of registers 212 or, alternatively, a specialized command that communicates the reference clock description (e.g., specification).

In step 506, storage module 506 configures itself to operate based on the received reference clock description (e.g., specification) from step 504. For example, storage module 120 configures whether clock generation circuit 206 continues to operate in a state where the reference clock signal is not being provided.

In a third embodiment, host 100 provides information to storage module 120 regarding host capabilities or limits placed upon storage module 120. For example, the host 100 may specify a maximum current consumed or one or more response times. In response, storage module 120 informs host 100 when the external reference clock signal is used and/or the properties of the external reference clock signal that are used by the storage module 120 to meet the limits placed upon storage module 120.

The storage module 120 includes controlling means 204 for controlling the storage module 120 in at least a first state and a second state. The storage module 120 includes storage means 214 for storing data. The storage means 214 may include a plurality of memory circuits. The power means 116 supplies power to the storage module 120. The storage module 120 includes reference clock means 206 provides an internal clock signal to the storage module 120. The storage module 120 includes data terminal means 215a, 215b for coupling the memory device to an external device. The storage module 120 includes clock generation means 206 coupled to the controlling means 204 and to the reference clock terminals 218b. The clock generation means 206 is configured for receiving an external clock signal from an external source and generating the internal clock signal based at least in part upon the external clock signal. The storage controller is configured to receive data, based on the internal clock signal, from the external device when the storage module 120 is in the second state. The storage module 120 includes first register means 212 for storing data that relates to a property of the external clock signal when the storage module 120 in the first state.

Although a feature may appear to be described in connection with a particular embodiment, one skilled in the art would recognize that various features of the described embodiments may be combined. Moreover, aspects described in connection with an embodiment may stand alone.

What is claimed is:

1. A storage device comprising:
a storage controller including a control circuit to operate the storage device in at least a first state or a second state;
blocks of memory coupled to the storage controller, each of the blocks of memory having a plurality of memory circuits to store data, the blocks of memory collectively forming a storage;
a power supply terminal to supply power to the storage device;
a reference clock terminal configured to provide to the storage module an external clock signal from a first external device;
a data terminal coupled to the storage controller and configured to couple to a second external device;
a clock generation circuit coupled to the storage controller and the reference clock terminal, wherein the clock generation circuit is configured to receive the external clock signal and to generate an internal clock signal based at least in part upon the external clock signal, and wherein the storage controller is configured to receive data, based on the internal clock signal, from the second external device in response to the storage device being in the second state; and
a first set of registers comprising one or more registers to store data that relates to a property of the external clock signal, in the first state of the storage device.

2. The storage device of claim 1, wherein the clock generation circuit includes a phased locked loop (PLL).

3. The storage device of claim 1, wherein the property of the external clock signal indicates whether the external clock signal is specified by the storage device in the first state.

4. The storage device of claim 1, further comprising:
a second set of registers comprising one or more registers containing data that describes a property of the external clock signal in the second state.

5. The storage device of claim 1, wherein the property of the external clock signal in the first state comprises an indication of a frequency, a frequency error, an input voltage, a rise time, a fall time, a duty cycle, a phase noise, a noise floor density, or an input impedance.

6. The storage device of claim 1, wherein the storage controller is configured to transfer data, based on the internal clock signal, on the data terminal in response to the storage device being in the second state.

7. The storage device of claim 1, wherein the storage controller is further configured to receive an indication of the property of the external clock signal on the data terminal when the storage device is in the first state.

8. The storage device of claim 1, wherein the storage controller is further configured to transmit an indication of the property of the external clock signal that relates to the first state on the data terminal

9. The storage device of claim 1, wherein the data that relates to the property of the external clock signal when the storage device is in the first state also relates to the property of the external clock signal in at least the second state.

10. A memory device comprising:
controlling means for controlling the memory device in at least a first state and a second state;
storage means for storing data, the storage means comprising a plurality of memory circuits;
power means for supplying power to the memory device;
reference clock means for providing an internal clock signal to the memory device;
data terminal means for coupling the memory device to an external device;
clock generation means coupled to the storage controller and to the reference clock terminal, the clock generation means configured for:
receiving an external clock signal from an external source; and
generating the internal clock signal based at least in part upon the external clock signal, wherein the storage controller is configured to receive data, based on the internal clock signal, from the external device when the memory device is in the second state; and
first register means for storing data that relates to a property of the external clock signal, in the first state of the memory device.

11. The memory device of claim 10, wherein the clock generation means includes a phased locked loop (PLL).

12. The memory device of claim 10, wherein the property of the external clock signal indicates whether the external clock signal is used by the memory device in the first state.

13. The memory device of claim 10, further comprising:
a second set of registers comprising one or more registers containing data that describes a property of the external clock signal in the second state.

14. A host device, comprising:
a system memory;
a reference clock that is configurable by the host device;
an interface for interfacing the host device with a storage device, the storage device comprising a plurality of memory circuits to store data, the storage device operating in at least a first state and a second state;
a host controller configured to:
send, to the storage device, a request for reference clock specifications;
receive, from the storage device, the reference clock specifications; and
configure the reference clock according to the reference clock specifications; and
wherein the reference clock is further configured to provide a reference clock signal to the storage device.

15. The host device of claim 14, wherein the storage device generates an internal clock signal based on the reference clock signal.

16. The host device of claim 15, wherein the storage device transfers data from the storage device to the host device, based on the internal clock signal, when the storage device is in the second state.

17. The host device of claim 14, wherein a property of the reference clock signal indicates whether the reference clock signal is specified by the storage device when the storage device is in the first state.

18. A method, comprising:
receiving, at a memory device, a request from a host device to provide reference clock specifications;
reading data from one or more registers of the memory device;
determining the reference clock specifications based at least partly on the data;
sending the reference clock specifications from the memory device to the host device; and
receiving, by the memory device, a reference clock signal that has parameters according to the reference clock specifications.

19. The method of claim 18, further comprising generating, by the memory device, an internal clock signal based on the reference clock signal.

20. The method of claim 19, further comprising transferring data from the memory device to the host device, based on the internal clock signal, when the storage device is in the second state.
